(19) United States
(12) Patent Application Publication
(10) Pub. No.: US 2008/0232199 A1
(43) Pub. Date: Sep. 25, 2008

(54) Time Management Device

(76) Inventor: Leslie Shafton, Evanston, IL (US)

Correspondence Address: CARDINAL LAW GROUP, Suite 2000, 1603 Orrington Avenue, Evanston, IL, 60201, US

(21) Appl. No.: 11/738,934

(22) Filed: Apr. 23, 2007

Related U.S. Application Data
(60) Provisional application No. 60/896,746, filed on Mar. 23, 2007.

(51) Int. Cl. G04F 10/00

(52) U.S. Cl. 368/109; 368/107

(57) ABSTRACT

A time management device includes a body portion including a front side and a back side, the front side including at least one elapsed time indicator, and at least one of the front side and back side including a programmable elapsed time controller, wherein the programmable elapsed time controller receives at least one time indicator and actuates at least one of the elapsed time indicators responsive to the time indicator, and a support portion connected to the body, the support portion configured to mate with a door knob and support the body on the door knob.

### RELATED APPLICATIONS

This application claims the benefit of U.S. Provisional Patent Application 60/896,746 filed Mar. 23, 2007, the entirety of which is incorporated herein by reference.

### FIELD OF THE INVENTION

This invention relates generally to time management devices. More specifically, the invention relates to mounted time management devices.

### BACKGROUND OF THE INVENTION

When a child needs to take a nap, go to sleep for the night, or be confined to his room for a period of “quiet time”, it is helpful to provide the child with a device to allow a child, who cannot tell time yet, a way to be informed when the nap period, or quiet time in his room has been completed. The prior art has attempted to fill this need, but problems still exist.

Often, the child does not want to nap, and the parent would benefit from the ability for the child to better understand when the child can leave the room. This ability is hampered by the child's likely inability to tell time by consulting a prior art time piece, such as a digital clock.

It is desirable to position such a device so that the child must view the timer prior to leaving a room. Also, as noted, a child may need to be required to have quiet time in his room for a period of time when the child may not be sleeping, or taking a nap to which the prior art displays may not be applicable. A need exists to make the child aware when the period of quiet time in his room has been completed. Further, a child, due to curiosity, or being rebellious, may pick-up, or move the timing device, which could lead to damage to the timing device, or relocation of the timing device to a location that is not easily viewed by the child.

### SUMMARY OF THE INVENTION

A first aspect of the invention includes a time management device that includes a body portion including a front side and a back side. The front side includes at least one elapsed time indicator, and at least one of the front side and back side includes a programmable elapsed time controller. The programmable elapsed time controller receives at least one time indicator and actuates at least one of the elapsed time indicators responsive to the time indicator. A support portion connected to the body is configured to mate with a door knob and support the body portion on the door knob.

Another aspect of the invention provides a method for managing time. The method includes receiving a time indicator from a programmable elapsed time controller, displaying at least one elapsed time indicator based on the received input, and supporting the time management device on a doorknob.

The foregoing embodiment and other embodiments, objects, and aspects as well as features and advantages of the present invention will become further apparent from the following detailed description of various embodiments of the present invention. The detailed description and drawings are merely illustrative of the present invention, rather than limiting the scope of the present invention being defined by the appended claims and equivalents thereof.

### BRIEF DESCRIPTION OF THE DRAWINGS

FIG. 1 is a front view of an embodiment of a time management device, in accordance with one aspect of the invention;

FIGS. 2A through 2F illustrate other embodiments of a time management device in accordance with one aspect of the invention;

FIG. 3 is a front view of an alternate embodiment of the time management device, in accordance with one aspect of the invention;

FIG. 4 is a rear view of one embodiment of the time management device, in accordance with one aspect of the invention;

FIG. 5 is a view of one embodiment of the time management device as viewed from the side and with the elapsed time indicator configured as a digital display, in accordance with one aspect of the invention;

FIG. 5A is a front view of the time management device of FIG. 5 utilizing another embodiment of the elapsed time indicator configured as an analog device and with associated components, in accordance with one aspect of the invention;

FIG. 5B is a front view of the time management device of FIG. 5 utilizing another embodiment of the elapsed time indicator configured as an analog device and with associated components, in accordance with one aspect of the invention;

FIG. 5C is a front view of the time management device of FIG. 5 utilizing another embodiment of the elapsed time indicator configured in the “stoplight configuration” with associated components in accordance with one aspect of the invention;

FIG. 5D is a section view of the time management device of FIG. 5 utilizing another embodiment of the elapsed time indicator configured in the “stoplight configuration” with associated components in accordance with one aspect of the invention;

FIG. 6 illustrates an embodiment of a support portion of a child's time management device, including a locking portion that attaches to a body portion, in accordance with one aspect of the invention;

FIG. 7 is a view showing the child's time management device utilizing a remote control device, in accordance with one aspect of the invention; and

FIG. 8 illustrates a method of using the child's time management device, in accordance with one aspect of the invention.

### DETAILED DESCRIPTION OF THE DRAWINGS

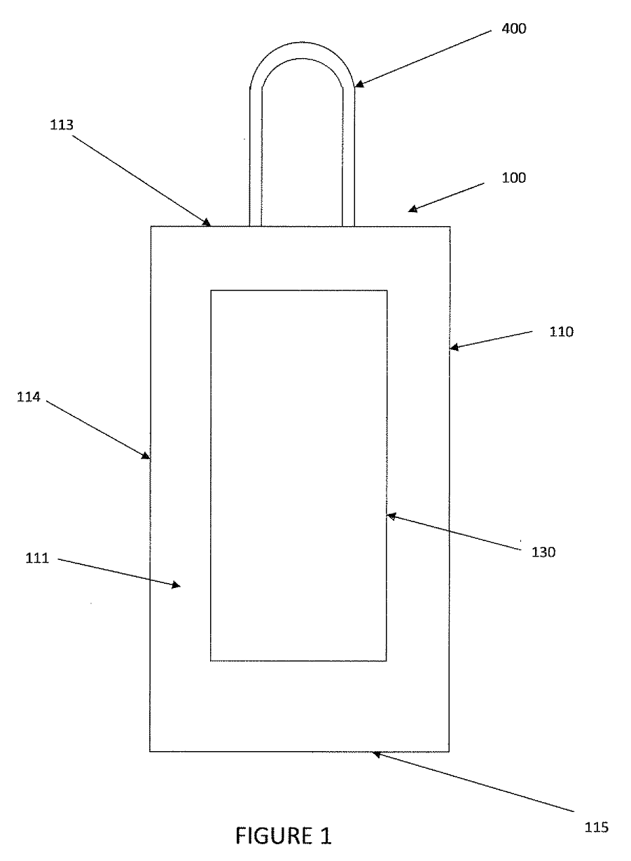

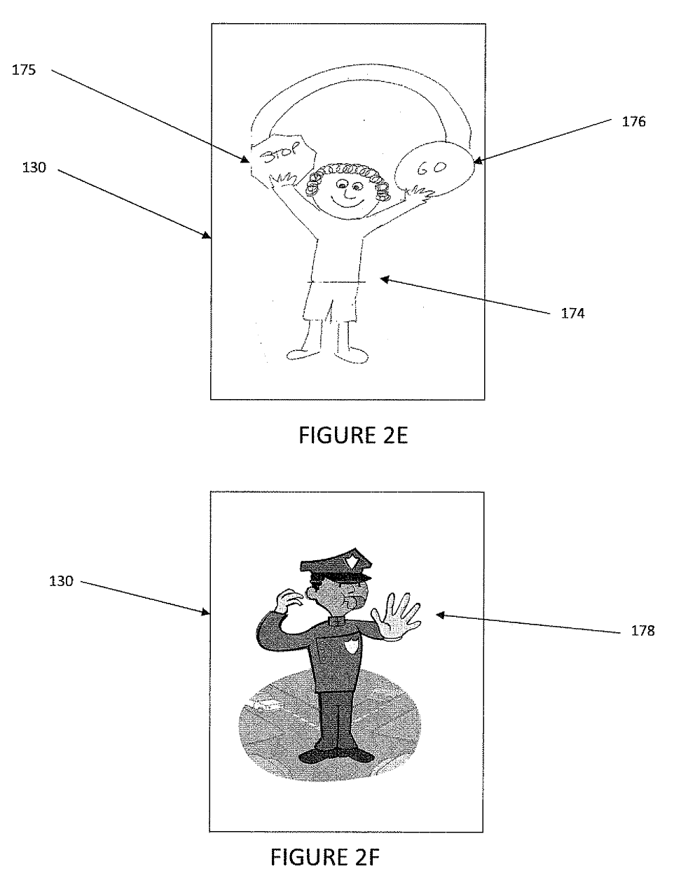

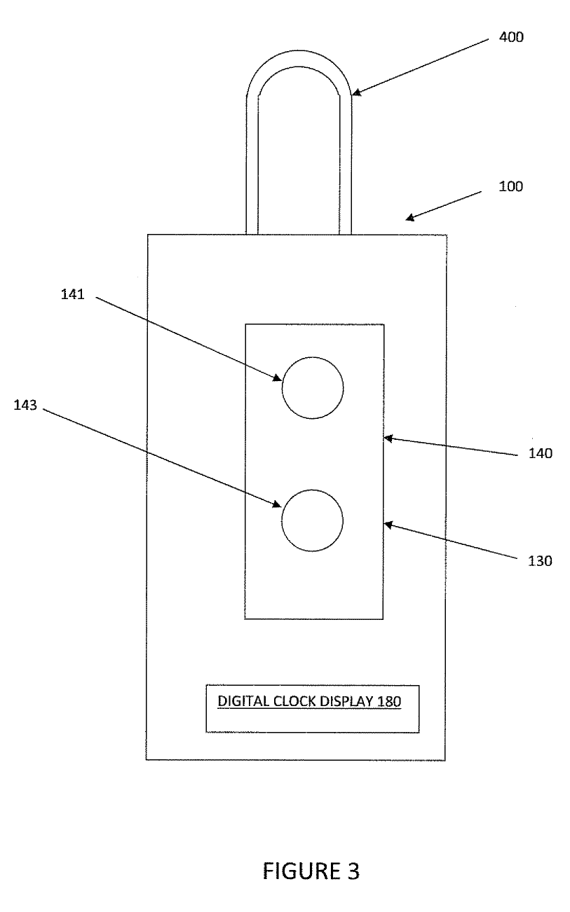

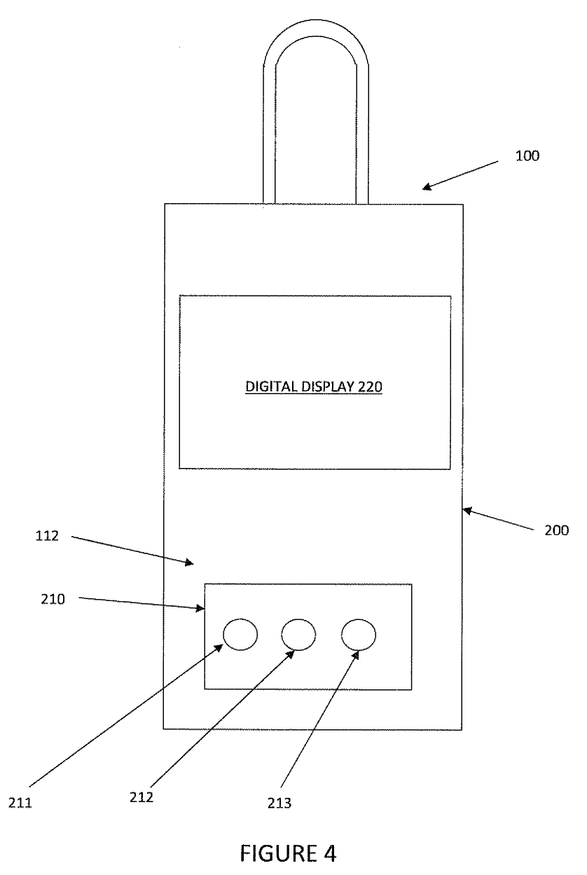

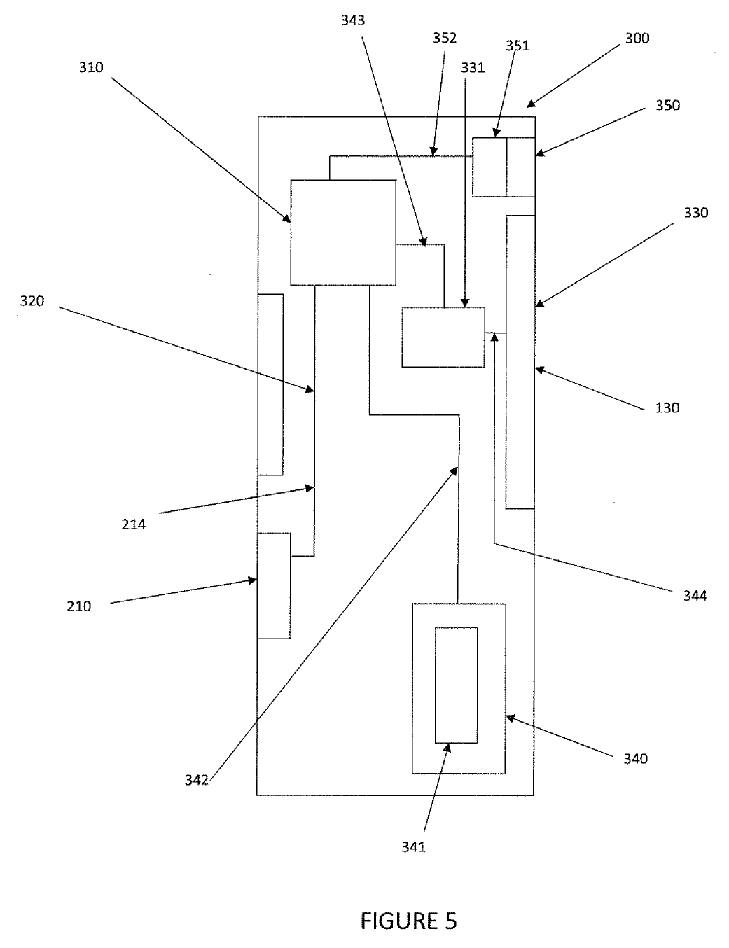

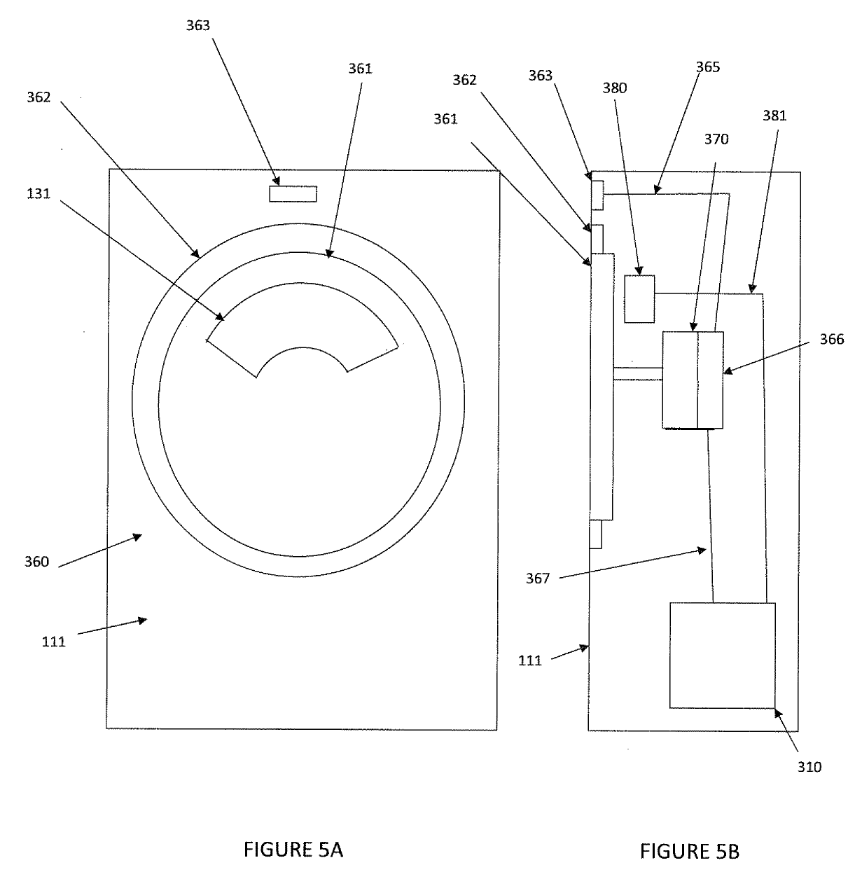

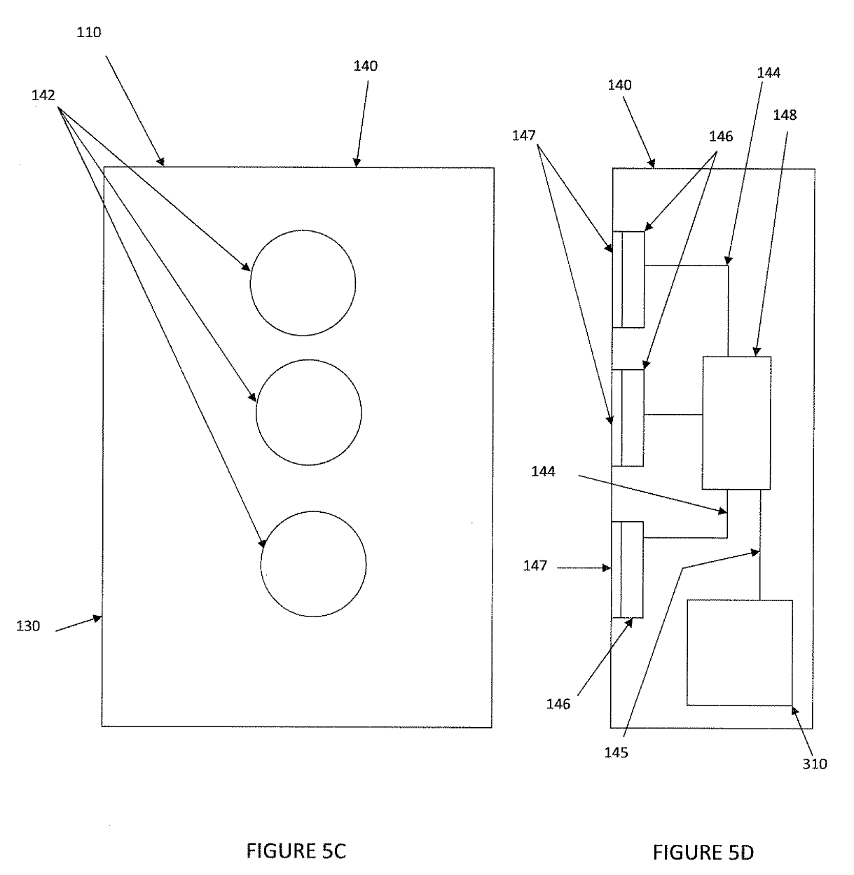

FIG. 1 illustrates a front view of a time management device 100 in accordance with one aspect of the invention for use by a child. The time management device 100 includes a body portion 110 including a front portion 111, a rear portion 112 (see FIG. 4), a top portion 113, side portions 114 and a bottom portion 115. The time management device also includes a support portion 400. The front portion 111 includes at least one elapsed time indicator 130. The elapsed time indicator is in electrical communication with at least one elapsed time controller, such as elapsed time controller 210 illustrated in FIG. 4 or elapsed time controller 310 in FIG. 5. The elapsed time controller receives at least one time indicator and actuates the at least one elapsed time indicator based on the received time indicator. In one embodiment, the elapsed time controller is a timepiece (such as a digital or analog clock) that includes a timer function to track a controllable span of time. In one embodiment, the elapsed time controller receives input from a user interface to establish the controllable span of time, counts down (or up) the controllable span of time, and then actuates at least one of the elapsed time indicators responsive to the controllable span of time.

The support portion 400 connects to the body portion 110. In one embodiment, the support portion 400 and body portion each include a locking mechanism configured to releasably lock the support portion 400 to the body portion 100. The locking mechanism can be any appropriate locking device, such as a combination lock or keyed lock. Other locking mechanisms can also be used, such as latches, hooks, or the like.

In one embodiment, body portion 110 comprises a substantially polygonal form. In other embodiments, body portion 110 comprises a shape evocative of a character, or anthropomorphic form. In one embodiment, body portion 110 comprises a policeman shape. In another embodiment, body portion 110 comprises a teddy bear shape. In another embodiment, body portion 110 comprises a mascot shape. These delineated shapes are not limiting, as body portion 110 can assume any desired shape.

The elapsed time indicator 130 is a control device to illustrate whether the predetermined time span has elapsed or is currently elapsing. In one embodiment, elapsed time indicator 130 includes at least a first color indicator and a second color indicator, such that the first color indicator differs from the second color indicator in at least one respect. In one embodiment, the elapsed time indicator 130 includes a first light and a second light, such that the first light differs from the second light in at least one respect. In one embodiment, the first light and second light are separated from each other, while in other embodiments, the first light and second light are different colors. In one embodiment, at least two lenses provide different colors for the first and second lights. In one embodiment, the first light is a red light, and the second light is a green light. In one embodiment, the elapsed time indicator 130 is non-alphanumeric. In one embodiment, the elapsed time indicator 130 comprises a first image and a second image. In one embodiment, the first image and second image illustrate opposing images of an anthropomorphic character, such as a sleeping teddy bear and an awake teddy bear.

In one embodiment, upon setting a predetermined time span, the first light is actuated and upon the elapse of the predetermined time, the second light in actuated. In other embodiments, the first image is displayed while the time is elapsing, and the second image is displayed when the time has elapsed.

The user interface is, in one embodiment, disposed within the body portion 110. In another embodiment, the user interface is disposed within a remote control device. The remote control device can operate using appropriate techniques, such as RF signals, infrared signals, or wireless communication techniques, such as 802.11, Bluetooth, any FCC Part 13 protocols, or the like. In other embodiments, the elapsed time controller receives commands from both a user interface carried by the body portion 110 and a remote control device. The user interface can include button controls, a keypad, knobs, dials, or the like. User interfaces for controlling time devices, such as analog or digital clocks and stopwatches, are known, and any appropriate user interface may be used within the disclosures herein.

In embodiments featuring a user interface disposed upon the body portion 110, the user interface can be disposed on the front of the body portion, sides of the body portion, or on the back of the body portion. In one embodiment, the user interface is covered by a removable cover. In one embodiment, the removable cover is lockable to reduce tampering.

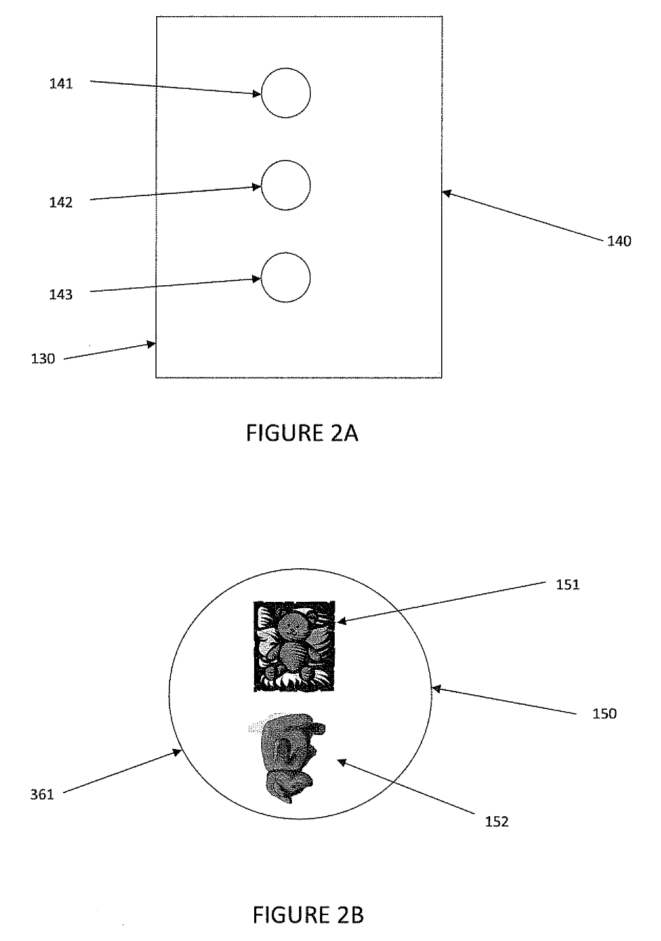

FIGS. 2A-2F illustrate alternate embodiments of the elapsed time indicator 130 (see FIG. 2A) on the front portion 111 of the body portion 110. FIG. 2A illustrates the elapsed time indicator 130 in a “stoplight configuration” 140, with red 141, yellow 142 and green 143 lights, utilizing a digital display 330 (see FIG. 5). While illustrated with three sources of illumination in FIG. 2A, any number of lights can be used, including a single light configured to change illumination color, such as with a series of lenses, or a variety of LED devices. FIGS. 2B-2D illustrate the use of an analog disc 361 (see FIGS. 5A and 5B) with at least a first and second images, as illustrated on FIGS. 2B-2D. In other embodiments, the first and second images can be fixed upon the body portion without inclusion on the analog disc, such as with a matching number of lenses covering light sources. FIG. 2B illustrates the analog disc 361 configured in an anthropomorphic character configuration 150, such as a sleeping bear 151 and an awake bear 152. Although illustrated with a ‘bear’ motif, any character can be used, including characters associated with stories, movies or the like. The analog disc 361 is positioned behind the front panel 111 (see FIGS. 5A and 5B). In one embodiment, a circular window 131 (see FIG. 5A) allows that only the sleeping bear will be able to be viewed in the elapsed time indicator 130 (see FIG. 5A) when a child is to be sleeping. On completion of the predetermined time span, the analog disc 361 rotates, such that the awake bear 152 will appear in the circular window 131 (see FIG. 5A). In other embodiments, the analog disc 361 can display at least a first image and a second image, with the second image different in at least one respect from the first image, such as illustrated in FIGS. 2B-2D, with only one of the first image and the second image shown at a time. FIG. 2C illustrates the analog disc 361 configured as a “smiley face” 160 and as a “frowning face” 165. FIG. 2D illustrates the analog disc 361 configured as the sun 170 and the moon 172. FIG. 2E illustrates an anthropomorphic character 174 holding stop 175 and go 176 signs. Lights (not shown) behind the anthropomorphic character 174 and the stop 175 and go 176 signs facilitate viewing of the anthropomorphic character 174 and the stop 175 and go 176 signs. FIG. 2F illustrates the elapsed time indicator as a policeman 178. A light (not shown) behind the policeman 178 illuminates the policeman 178 to indicate when a child is to remain in a room. When the light behind the policeman 178 is no longer illuminated, the child may leave the room. In another embodiment, a first light is disposed in a first portion of the policeman, such as a hand, and the second light is disposed in a second portion of the policeman, such as a second hand, and the first and second light illuminate responsive to the predetermined time span. These are only exemplary embodiments for the time management device and the invention is not limited to the embodiments illustrated in FIGS. 2A-2F.

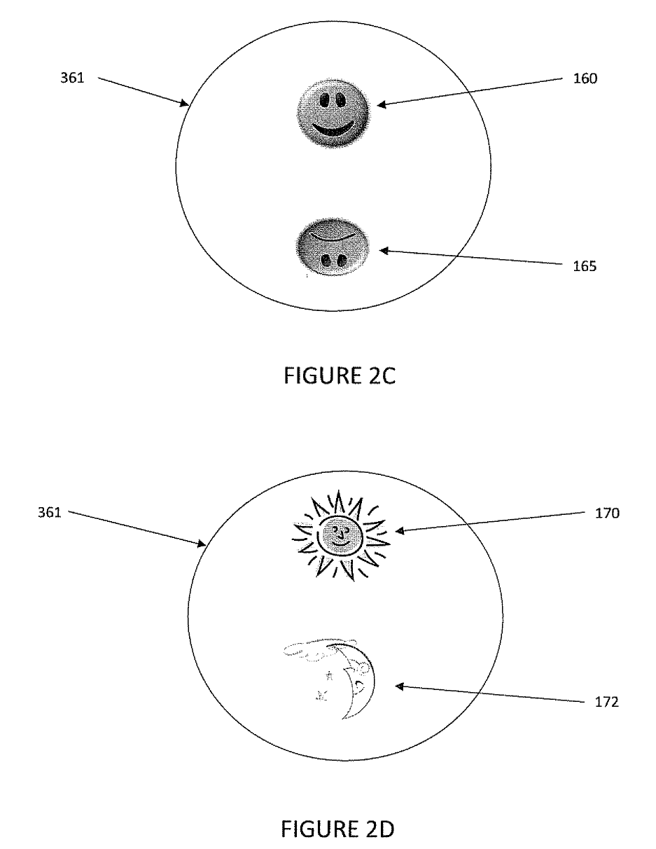

FIG. 3 illustrates an alternate embodiment of the time management device area, in accordance with one aspect of the invention. In FIG. 3, the elapsed time indicator 130 is configured in a “stop and go light configuration” 140 as red 141 and green 143 lights, and including a digital clock display 180. This embodiment may be useful when an adult is in a room with the door to the room closed, such as a college dorm room that is occupied by a student who is studying and does not which to be disturbed.

FIG. 4 illustrates one embodiment of a rear portion 112 of the time management device 100, in accordance with one aspect of the invention. The time management device includes a rear panel 200 including a programmable elapsed time controller 210 and digital display 220. In one embodiment, the programmable elapsed time controller 210 includes a start time button 211, a stop time button 212, and a mode selector button 213, indicating whether a nap, nighttime sleep, or quiet time mode is selected. In another embodiment, the programmable elapsed time controller 210 is a digital or analog timepiece including a stopwatch function configured to count down time from a predetermined time span. The programmable elapsed time controller 210 sends a signal 214 (see FIG. 5) based on user input to a elapsed time controller 310 (see FIG. 5) for processing.

FIG. 5 illustrates a side view of the interior portion 300 of the time management device portion, as viewed from the side. The interior portion includes an elapsed time controller 310 and electrical wiring 320 connecting the programmable elapsed time controller 210 with the elapsed time controller 310. The elapsed time indicator 130 in one embodiment is a digital display 330, as shown in FIG. 5. The digital display is controlled by a controller 331. A power source 340, such as supplied by a battery 341 provides power to the time management device. In one embodiment, battery 341 is a low voltage battery. In one embodiment, the power is DC power. Electrical wiring 342 connects the power source with the elapsed time controller 310. The controller 331 receives commands from the elapsed time controller 310 via electrical wiring 343 and processes these commands to display the appropriate display by electrical wiring 344. In one embodiment, a sound generator 350 and sound generator controller 351 are connected by electrical wiring 352 to give an audio indication of time management.

FIGS. 5A and 5B illustrate one embodiment of an analog elapsed time indicator 360, in accordance with one aspect of the invention. In one embodiment, elapsed time indicator 360 is a circular window 131, so that an analog disc 361, which has two or more images, as shown in FIGS. 2B-2D, will only show the applicable images, such as a sleeping bear 151 (see FIG. 2B), an awake bear 152 (see FIG. 2B), etc. In one embodiment, the analog configuration 360 includes an analog disc 361 that is driven by a motor 370, such as a stepping motor. The analog disc 361 contains images, such as a sleeping bear 151, or awake bear 152, as shown in FIG. 2B, or other similar figures, such as shown on FIGS. 2C and 2D.

In one embodiment, magnetic ring 362 is affixed to the outer diameter area of the analog disc 361. In such embodiments, the magnetic ring 362 facilitates the determination of analog disc 361 angular position by a sensor. In one embodiment, a sensor 363, such as a Hall effect sensor, senses disc angular disc position responsive to magnetic fields generated by the magnetic ring 362. The sensor sends a signal 365 to a motor controller 366 responsive to the sensed disc angular position. Based on signal 365 and at least one signal from elapsed time controller 310, motor controller 366 rotates analog disc 361. In one embodiment, electrical wiring 367 connects motor controller 366 and elapsed time controller 310. The analog disc 361, in one embodiment, is made of an at least partially translucent plastic material such that a light 380 placed behind the analog disc 361 illuminates the analog disc 361, for easier viewing by a child. In one embodiment, elapsed time controller 310 controls operation of the light 380 using signals carried on electrical wiring 381.

FIGS. 5C and 5D illustrate the elapsed time indicator 130 (not shown) configured in the “stoplight” configuration” 140, in accordance with one aspect of the invention. The stoplight configuration 140 includes a series of lights 146, colored lenses 147 and a lighting controller 148. The lights 146 and lighting controller 148 are connected via electrical wiring 144. The lighting controller 148 receives commands from the elapsed time controller 310 via electrical connection 145 and processes these commands to turn on and off the appropriate lights 141.

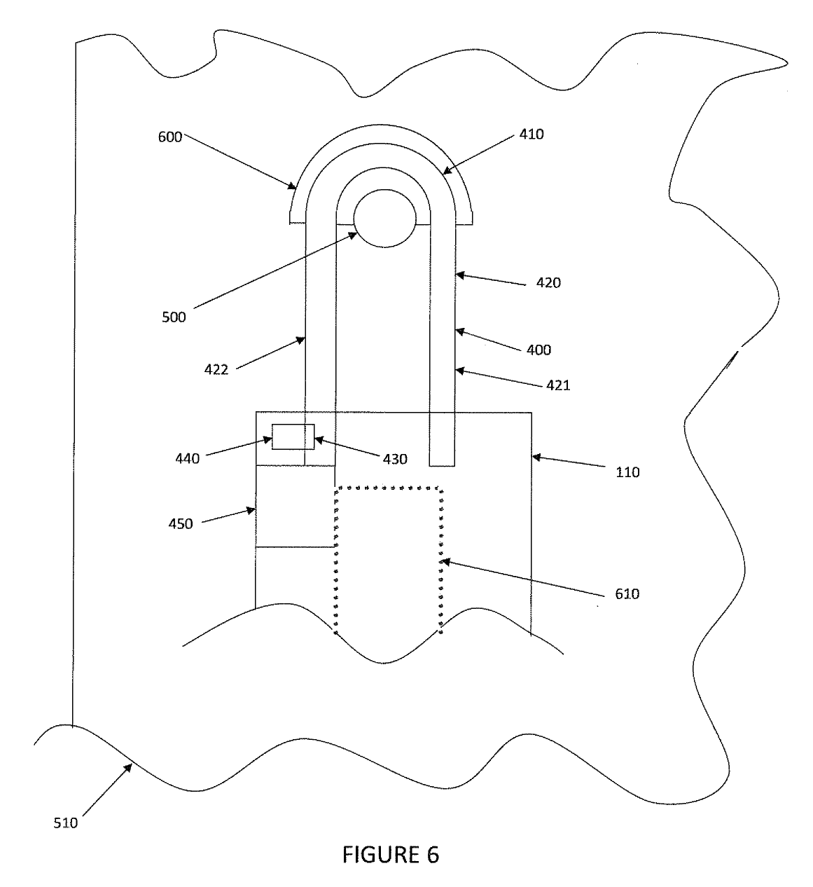

FIG. 6 illustrates the support portion 400 of the time management device, in accordance with one aspect of the invention. The support portion 400 includes an arcuate portion 410. In one embodiment, the support portion further includes at least one straight portion, 420. Support portion 400 is configured for installation on a door knob 500 of a door 510. In one embodiment, a first straight portion 421 is releasably connected to the body portion 110. In another embodiment, a second straight portion 422 is removedly connected to the body portion 110. The straight portion 422 includes a support portion locking mechanism 430 which engages a body portion locking mechanism 440. A key hole 450 is optionally located on the body portion 110 for insertion of a key (not shown) to release engagement of the body portion locking mechanism 440 and the support portion locking mechanism 430. The support portion 400 is configured such that when the support portion locking mechanism 430 is engaged with the body portion locking mechanism 440, the support portion 400 cannot be removed from a door knob 500 of a door 510 without the key.

FIG. 6 also illustrates the use of a cushioning member 600 on the support portion 400 and a separate cushioning 610 on the body portion 110. Use of cushioning members can reduce any possible marks or damage to either the door or the body portion.

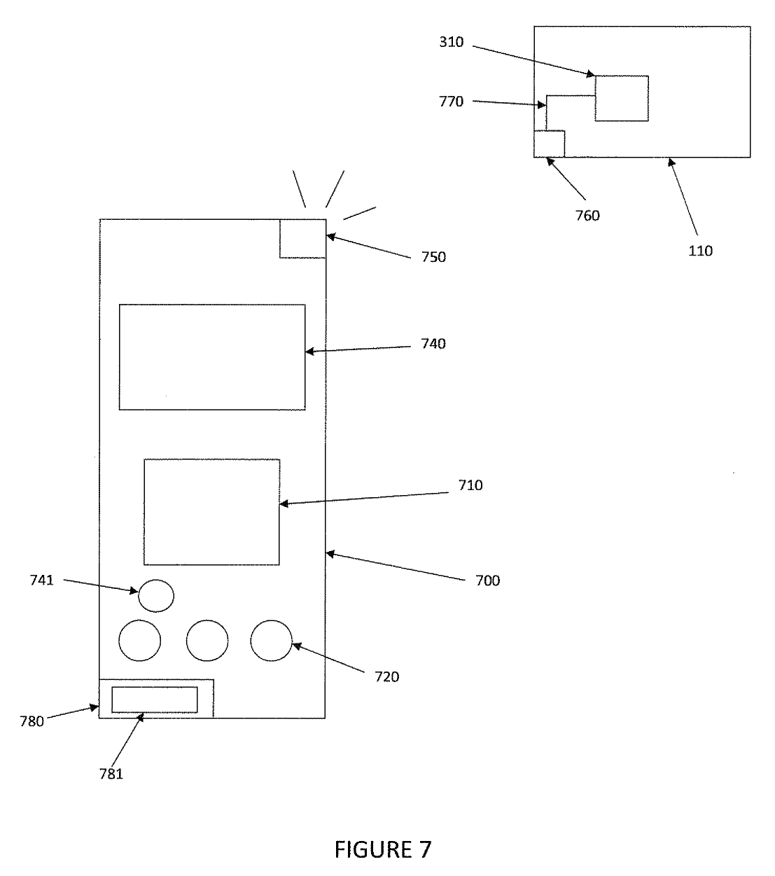

FIG. 7 illustrates the use of a remote control device 700 to optionally control functioning of the time management device 100, in accordance with one aspect of the invention. The remote control device 700 includes a keypad or other user interface 710 and control buttons 720 for entry of programmable elapsed time commands. In one embodiment, a digital display 740 on the remote control device provides a digital display of the entered commands. The remote control device 700 includes a transmitter 750 that transmits the commands to a receiver 760 in the body portion 110. Electrical wiring 770 connects the receiver 760 with the elapsed time controller 310. A power supply 780 supplies power to the remote control device 700 from batteries 781. The remote also includes an override button 741 to allow a user of a remote to override programmed commands previously sent to the time management device.

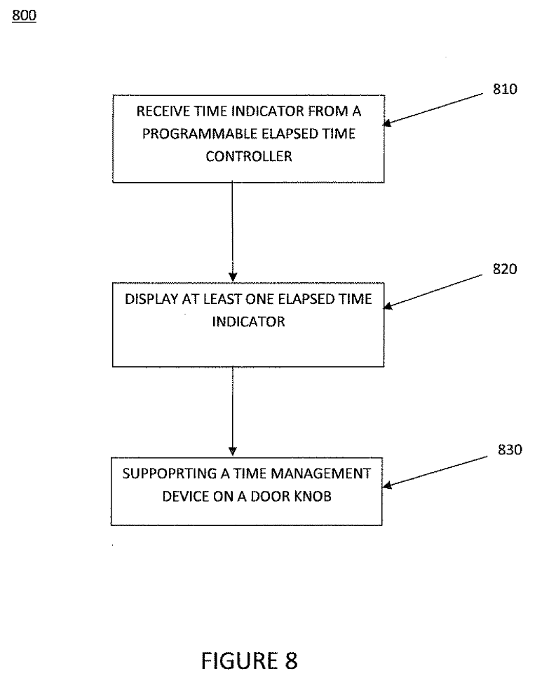

FIG. 8 illustrates a method 800 of using the time management device. The method 800 includes the first step of receiving a time indicator 810 as a programmable elapsed time controller. The next step 820 involves displaying at least one elapsed time indicator based on the received input in step 810. The next step 830 involves supporting a time management device on a door knob 500 (not shown).

In another embodiment, the user interface is configured as an SMS messaging device for sending and receiving text messages. In such embodiments, the time management device includes at least one transceiver for generating and receiving wireless communications, such as text messages or other forms of communication. Alternatively, the device can operate using packet data network protocols to send and receive various other forms of electronic communications, such as instant messaging, emails, or the like. In such embodiments, the device includes a message monitor visible when mounted on a doorknob. In one embodiment, the message monitor is one of the first elapsed time monitor and second elapsed time monitor. In other embodiments, the message monitor is a dedicated component. In one such embodiment, the device is configured to issue a notice, such as a predetermined message, in the event that the device is tampered with or moved. In one such embodiment, a gyroscope or other inertial sensor senses motion and issues the notice responsive to the sensed motion.

The disclosures herein provide for a timing device that is supported by a door knob, and which tracks a time span, actuating a first elapsed time indicator while the time is elapsing, and actuating a second elapsed time indicator when the time has elapsed. These disclosures may be advantageous for allowing children, or persons with differing levels of knowledge or mental ability, to monitor their ability to leave a circumscribed area, such as a bedroom, during a ‘nap time’ or ‘quiet time.’

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced herein.

What is claimed is:

1. A time management device comprising:
a body portion including a front side and a back side, the front side including at least one elapsed time indicator;
a programmable elapsed time controller configured to receive at least one time indicator and actuate at least one of the elapsed time indicators responsive to the time indicator; and
a support portion connected to the body, the support portion configured to mate with a door knob and support the body on the door knob.

2. The time management device of claim 1 wherein the programmable elapsed time controller is in communication with a user interface configured to control the elapsed time indicator responsive to input from the user interface.

3. The time management device of claim 1 wherein the elapsed time indicator is non-alphanumeric.

4. The time management device of claim 1 wherein the elapsed time indicator comprises at least two color indicators.

5. The time management device of claim 4 wherein the elapsed time indicator comprises at least a red light and a green light, wherein the red light illuminates until a specific amount of time has elapsed.

6. The time management device of claim 1 wherein the elapsed time indicator comprises at least a first image of at least one anthropomorphic character and a second image of the at least one anthropomorphic character, wherein the first image is different than the second image.

7. The time management device of claim 6 wherein the first image of at least one anthropomorphic character is formed as a sleeping teddy bear and the second image of the at least one anthropomorphic character is formed as an awake teddy bear.

8. The time management device of claim 1 wherein the support and the body portion each includes at least one locking mechanism configured to releasably lock the support portion to the body.

9. The time management device of claim 8 wherein the body includes a keyhole for insertion of a key for disengaging the body portion locking mechanism from the support portion locking mechanism.

10. The time management device of claim 1 wherein the elapsed time indicator of the time management device receives the time indicator from a remote control.

11. The time management device of claim 1 further comprising a user interface disposed on at least one of the front side and back side, the user interface in electrical communication with the programmable elapsed time controller.

12. The time management device of claim 1 further comprising at least one cushioning member attached to at least one of the group consisting of the body portion and the support portion.

13. The time management device of claim 1 wherein the programmable elapsed time controller is located on the back side of the body portion.

14. The time management device of claim 1 further comprising a sound generator in electrical communication with the controller and a speaker in electrical communication with the sound generator.

15. The time management device of claim 1 wherein the support portion includes an arcuate portion.

16. The time management device of claim 15 wherein the arcuate portion separates a first straight portion and a second straight portion.

17. A method for managing time, the method comprising:
receiving a time indicator from a programmable elapsed time controller;
displaying at least one elapsed time indicator based on the received input; and
supporting the time management device on a doorknob.

18. The method for managing time of claim 17, wherein the at least one elapsed time indicator comprises at least a first and second elapsed time indicator, and further comprising:
displaying the first time indicator in response to a first programmed time indicator and in response to a second programmed time indicator; and
actuating the second time indicator in response to a second programmed time indicator.
